(19) United States
(12) Patent Application Publication
(10) Pub. No.: US 2011/0246275 A1
(43) Pub. Date: Oct. 6, 2011

(54) DIGITAL WORK PROMOTION SERVER

(76) Inventors: Samuel J. Mendez, Carrollton, TX (US); Winston Samuel Ojeda, JR., San Antonio, TX (US)

(21) Appl. No.: 12/984,678

(22) Filed: Jan. 5, 2011

Related U.S. Application Data
(60) Provisional application No. 61/320,601, filed on Apr. 2, 2010.

(51) Int. Cl. G06Q 30/00

(52) U.S. Cl. 705/14.23

(57) ABSTRACT

A computer server for promotion of digital works is provided in one exemplary embodiment of the present invention. The computer server is configured to receive a digital work from a publisher over a first network connection. The computer server is configured to sell, over a second network connection to a premium buyer, a copy of the digital work to the premium buyer at a premium price. The computer server is configured to sell, over a third network connection to a subsequent buyer, a copy of the digital work to the subsequent buyer at the premium price or at a regular price. The computer server is configured to, in response to the sale to the subsequent buyer, provide a reward to the premium buyer.

### CROSS-REFERENCE TO RELATED APPLICATIONS

This application relates to, and claims the benefit of the filing date of, co-pending U.S. provisional patent application Ser. No. 61/320,601, entitled PRODUCT PROMOTER REWARDS PROCESS, filed Apr. 2, 2010, the entire contents of which are incorporated herein by reference for all purposes.

### TECHNICAL FIELD

The present invention relates to computer servers and, more particularly, to computer servers for distribution of digital works.

### BACKGROUND

The Internet has made music publishing available to virtually everyone. Because of the minimal costs associated with electronic distribution, an artist can easily offer music for sale online with little to no start-up cost. However, attracting the attention of the public remains difficult for artists with limited financial resources. Although websites and other Internet sites exist for offering music for sale, a single artist has difficulty standing out from all of the other artists on a site. A relatively unknown artist has little ability to draw the attention of the site's users and consequently little ability to sell music.

It would be advantageous if an artist could draw the attention of the public to the artist's work without having to expend significant financial resources.

### SUMMARY OF INVENTION

Accordingly, a computer server for promotion of digital works is provided in one exemplary embodiment of the present invention. The computer server is configured to receive a digital work from a publisher over a first network connection. The computer server is configured to sell, over a second network connection to a premium buyer, a copy of the digital work to the premium buyer at a premium price. The computer server is configured to sell, over a third network connection to a subsequent buyer, a copy of the digital work to the subsequent buyer at the premium price or at a regular price. The computer server is configured to, in response to the sale to the subsequent buyer, provide a reward to the premium buyer.

### DESCRIPTION OF DRAWINGS

FIG. 1 depicts a digital work promotion server and transactions involving it in accordance with an exemplary embodiment of the present invention.

FIG. 2 depicts steps included in the sale of a digital work in accordance with an exemplary embodiment of the present invention.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, specific details, and the like have been omitted inasmuch as such details are not considered necessary to obtain a complete understanding of the present invention, and are considered to be within the understanding of persons of ordinary skill in the relevant art.

The present invention is described primarily in terms of music, but it is also applicable to movies, books, photographs, and any other type of digital work which may be provided through a computer network. The functions of a digital work promotion server may be performed by a specially programmed computer. A digital work promotion server may include one or many specially programmed computers.

One method of programming a computer to function as a digital work promotion server is to provide the computer with computer-readable instructions encoded on a computer-readable medium, including a non-transitory computer-readable medium. The computer may operate as a digital work promotion server by executing the computer-readable instructions on an electronic data processor. Additionally, while the Internet is the preferred computer network for a digital work promotion server, any other computer network which provides the needed functionality can be used.

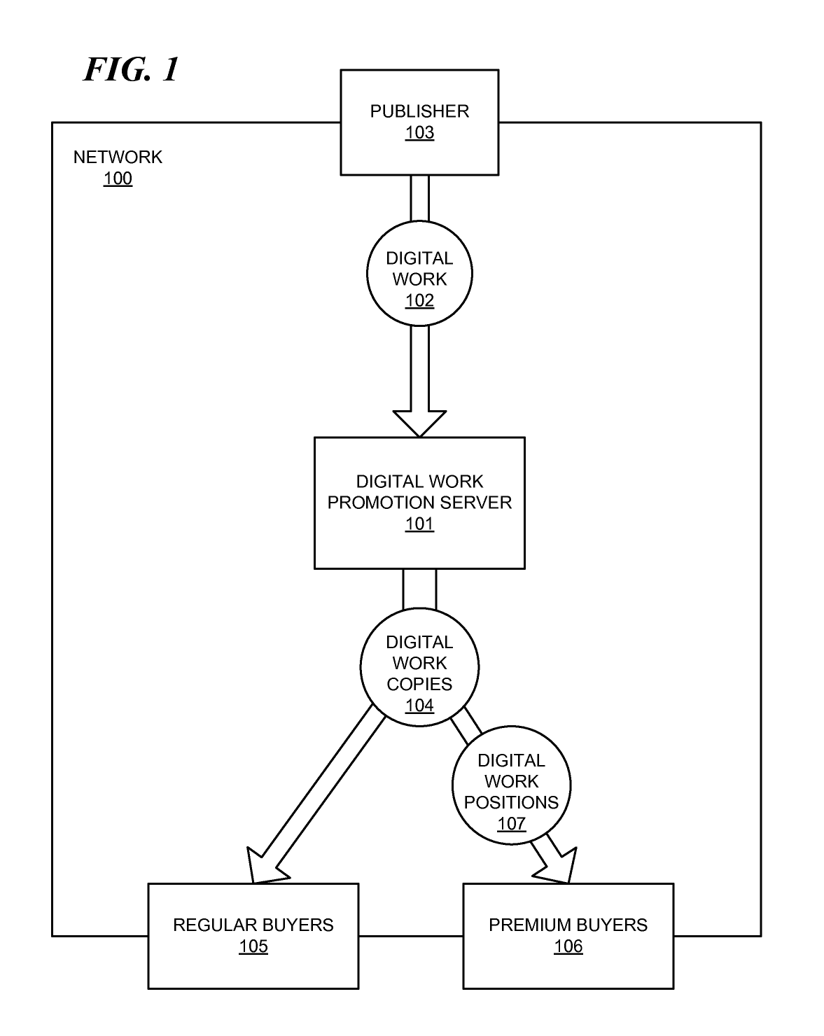

Referring to FIG. 1, illustrated is a computer network 100 having an exemplary digital work promotion server 101. Digital work promotion server 101 receives a digital work 102 from a digital work publisher 103 and sells digital work copies 104 to regular buyers 105 and premium buyers 106. Digital work promotion server 101 interacts with digital work publisher 103, regular buyers 105, and premium buyers 106 over the network 100. Commonly, a digital work promotion server 101 is an Internet web server having a website accessible by digital work publisher 103, regular buyers 104, and premium buyers 106 by a conventional web browser. Other methods of accessing digital work promotion server 101, such as computer software specific to accessing an Internet site operated by digital work promotion server 101, are also contemplated.

Publisher 103 may be any entity capable of selling digital work copies 104. For example, publisher 103 may be the artist who created digital work 102, a representative of the artist, or a music publishing company. Typically, publisher 103 would like to obtain greater exposure for digital work 102 in exchange for a portion of the revenue from sales of digital work copies 104.

Both regular buyers 105 and premium buyers 106 may be any members of the general public buying digital work copies 104 using the Internet site of digital work promotion server 101. Premium buyers 106 are distinguished from regular buyers 105 in that their “premium” purchases include a digital work position 107 in addition to a digital work copy 104. Ownership of digital work positions 107 entitles premium buyers 106 to rewards from future sales of digital work copies 104. Therefore, typical premium buyers 106 expect digital work 102 will be commercially successful or expect, through their efforts, to be able to make digital work 102 commercially successful. Possible rewards given to premium buyers 106 from a sale of a digital work copy 104 include a monetary payment and redeemable credit, such as store credit or frequent flyer miles. In an embodiment, digital work promotion server 101 may provide rewards automatically without requiring human action.

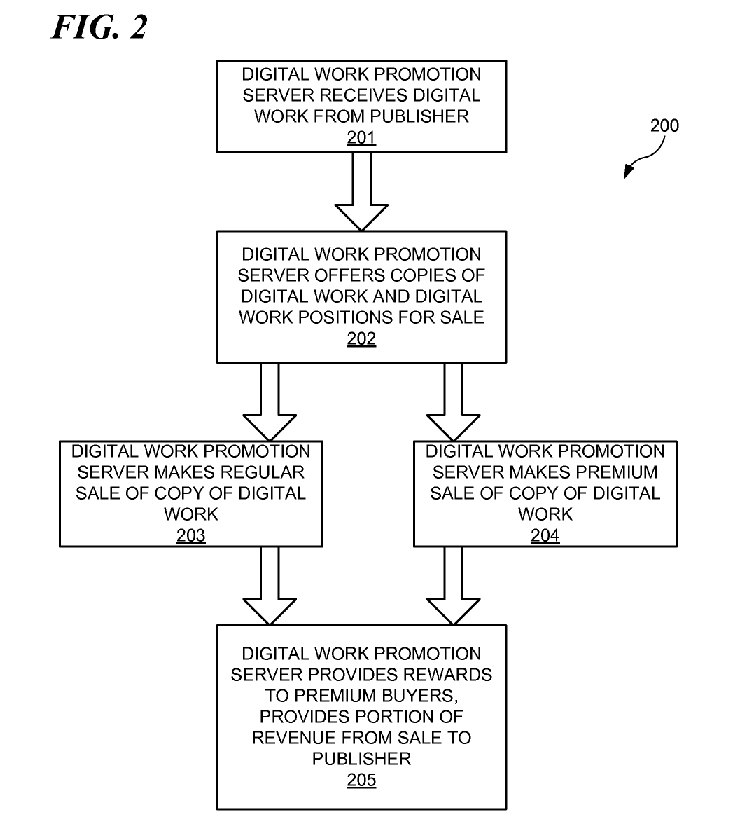

Referring to FIGS. 1 and 2, depicted is an exemplary method 200 performed by digital work promotion server 101. In step 201, digital work promotion server 101 receives digital work 102 from publisher 103. Publisher 103 may provide digital work 102 through a web-based upload via the network 100. As part of providing digital work 102, publisher 103 may provide an image associated with digital work 102 and a description of digital work 102. Publisher 103 may review how digital work 102 is to be sold by digital work promotion server 101 and approve of digital work promotion server 101 beginning to sell digital work 102.

In step 202, digital work promotion server 101 offers digital work copies 104 for sale. In an exemplary embodiment, digital work promotion server 101 adds digital work 102 to a database together with many other digital works which digital work promotion server 101 sells copies of. Users of the Internet site of digital work promotion server 101 may search the database to find digital works they are interested in.

Digital work promotion server 101 may make two types of sales of a digital work copy 104: a regular sale of a digital work copy 203 and a premium sale of a digital work copy 204. A premium sale 204 includes a digital work position 107 in addition to a digital work copy 104. Because of the inclusion of the digital work position 107, a premium sale 204 may be more expensive than a regular sale. The price for a regular sale 203 may be called the “regular price” and the price for a premium sale 204 may be called the “premium price” for a digital work copy 104. The regular price may typically be the normal price a digital work copy 104 is sold for at retail apart from digital work promotion server 101.

Different possible pricing mechanisms for both regular and premium sales include a fixed price, a variable price which increases as more digital work positions 107 are sold, and a price determined by an auction conducted by digital work promotion server 101. A buyer may make a purchase electronically, such as by providing a credit card number or checking account number.

To encourage potential buyers to devote attention to digital work promotion server 101, digital work promotion server 101 may randomly offer a visitor to its Internet site the opportunity to make a purchase of a randomly selected digital work at a discount for a very limited time, such as 30 seconds. The offer may be for a regular sale, a premium sale, or for a type of sale chosen by the visitor.

A limited quantity of digital work positions 107 is associated with any a given digital work 102. When all digital work positions 107 have been purchased, no more premium sales may be made. Digital work positions 107 may also be only available for a certain amount of time, after which no more premium sales 204 may be made regardless of whether the fixed quantity has been sold. An interested buyer may choose whether to purchase by a regular sale 203 or by a premium sale 204.

Upon purchasing by a regular sale 203 or a premium sale 204, a buyer may receive a digital work copy 104 through the network 100. The digital work copy 104 may be provided via browser download, electronic mail, or some other means of providing a digital work copy 104. The digital work copy 104 may come with digital rights management technology to prevent the buyer from making further copies.

Upon purchasing by a premium sale 204, a premium buyer 106 may receive a digital work position 107 in the digital work 102. A digital work position 107 may be intangible and exist only as a record in digital work server 101 associated with a user account of the premium buyer 106. Ownership of a digital work position 107 entitles a premium buyer 106 to rewards from future sales of copies of digital work 104. Some digital work positions 107 may be retained indefinitely. Others may last for only a finite amount of time, after which the premium buyer 106 will no longer be a premium buyer and will no longer be entitled to rewards from future sales. The rewards from each future sale may be a portion of the revenue from the sale, calculated based on the revenue from the sale, or set independently of the revenue from the sale.

In step 205, in response to any sale, whether a regular sale 203 or a premium sale 204, digital work promotion server 101 may provide rewards to any premium buyers 106. A premium buyer 106 may receive rewards regardless of whether the sale was the result of efforts by that particular premium buyer 106. In addition, each premium buyer 106 may be limited to ownership of a single digital work position 107 in any given digital work 102. In a further embodiment, premium buyers 106 may receive rewards from sales of works related to, but not the same as, a digital work 102 which they own digital work positions 107 of. For example, a premium buyer 106 who owns a digital work position 107 of one song in an album may also receive rewards from sales of other songs in the same album.

For digital works 102 where not all digital work positions 107 have been sold, any revenue that would have been allocated to the unsold digital work positions 107 may be divided, in equal or unequal parts, among the existing premium buyers 106 in one embodiment. In alternative embodiments, this revenue may be retained by digital work promotion server 101, given to publisher 103, or divided according to a combination of the three options.

Also in step 205 in response to any sale, digital work promotion server 101 provides a portion of the revenue from the sale to the publisher 103. The remainder of the revenue from the sale is retained by digital work promotion server 101. The revenue retained by digital work promotion server 101 may fund the rewards provided to premium buyers 106.

As is evident from the above description, many different parameters may be set for sales of a digital work 102. These parameters include, but are not limited to: how the price at which regular sales 203 and premium sales 204 are made is to be determined, whether by fixed prices, variable prices, or determined by auction, whether premium sales are to be made prior to any regular sales or concurrently with regular sales, a maximum number of digital work copies 104 which may be sold, a maximum number of digital work positions 107 which may be sold, what rewards are associated with ownership of a digital work position 107, the length of time digital work positions 107 may be sold, the length of time a premium buyer 106 may retain a digital work position 107, and so on. Some, none, or all of these parameters may be determined by the publisher 103 when the publisher provides the digital work 102 at step 201. Any parameters not determined by publisher 103 may be determined by digital work promotion server 101.

Because premium buyers 106 receive a portion of the revenue from each sale of digital work 102, they have a financial incentive to promote digital work 102 to others. In addition, premium buyers 106 may also enjoy digital work 102 and believe others may enjoy digital work 102. Therefore, premium buyers 106 can be expected to encourage others to purchase digital work 102 through social media, other electronic communication, word-of-mouth communication, and so on. Thus, publisher 103 has the opportunity to obtain increased sales and market exposure. In exchange for this opportunity, digital work promotion server 101 may retain a portion of the revenue from sales of digital work copies 104. This retained revenue may fund the rewards provided to premium buyers 106, or may be divided among premium buyers 106 and digital work promotion server 101.

To further encourage a premium buyer 106 to promote a digital work 102, digital work promotion server 101 may permit premium buyers 106 to sell their digital work positions 107. The buyer of the digital work position 107, rather than the original premium buyer 106, would then become the premium buyer 106 and receive rewards from future sales of the digital work 102. Thus, a buyer of a digital work position 107 will be more likely to pay more for a digital work 102 which is in demand, giving the original premium buyer 106 selling the digital work position 107 a further incentive to promote the digital work 102 and increase demand for it. If ownership of digital work positions 107 is maintained by digital work server 101, digital work server 101 can transfer a digital work position 107 from one user of digital work server 101 to another user simply by modifying its records.

In a further embodiment, individuals may form groups of individual users of digital work promotion server 101. Groups may also be called labels, studios, or teams. A group may itself own digital work positions 107, and its members may purchase digital work positions 107 for their group. The revenues from digital work positions 107 owned by a group may be divided among the members of the group.

Groups may be beneficial to the promotion of digital works because they encourage users of digital work promotion server 101 to interact with one another. To encourage the formation of groups, the number of digital work positions 107 which may be owned by an individual premium buyer 106 may be limited. For instance, an individual premium buyer 106 may be only permitted to own a single digital work position 107 in each digital work 102. However, the number of digital work positions 107 which may be owned by a group may be unlimited. Therefore, an individual who strongly believes in the future success of a particular digital work 102 may form a group with other like-minded individuals.

In addition to rewards provided from ownership of a digital work position 107, digital work promotion server 101 may offer users “activity rewards” as incentives for certain activities, including listening to and purchasing digital works, offering suggestions, taking quizzes, using other features of digital work promotion server 101, promoting of the Internet site of digital work promotion server 101, and promoting digital works. Digital work promotion server 101 may also provide individualized directions to certain activities for each of its users, and following these individualized directions may give a user the opportunity to obtain more activity rewards than would be obtained otherwise.

The activity rewards may be provided through a point system, where the user's activities award the user points and the user receives each reward after acquiring a certain number of points associated with that reward. For example, the ability to form or join a group with other individuals may be a reward which requires a certain number of points. The users of digital work promotion server 101 may also be classified into levels, and receiving points may allow a user to ascend to higher levels. This ascension may itself be considered an activity reward.

Having thus described the present invention in various embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of various embodiments.

We claim:

1. A computer server for promotion of digital works, the computer server configured to:
receive a digital work from a publisher over a first network connection;
sell, over a second network connection to a premium buyer, a copy of the digital work to the premium buyer at a premium price;
sell, over a third network connection to a subsequent buyer, a copy of the digital work to the subsequent buyer at the premium price or at a regular price; and
in response to the sale to the subsequent buyer, provide a reward to the premium buyer.

2. The computer server of claim 1, wherein the first network connection, the second network connection, and the third network connection comprise Internet connections.

3. The computer server of claim 1, wherein the digital work comprises at least one of an audio track, a video, or a book.

4. The computer server of claim 1, wherein the reward comprises a portion of revenue from the sale to the subsequent buyer.

5. The computer server of claim 1, wherein the reward comprises redeemable credit.

6. The computer server of claim 1, further configured to:
in response to the sale of the digital work to the premium buyer, provide a portion of revenue from the sale to the publisher; and
in response to the sale of the digital work to the subsequent buyer, provide a portion of revenue from the sale to the publisher.

7. The computer server of claim 1, wherein the subsequent buyer is a second premium buyer and further configured to:
sell the copy of the digital work to the second premium buyer at the premium price; and
sell, over a fourth network connection to a second subsequent buyer, a copy of the digital work to the second subsequent buyer;
in response to the sale to the second subsequent buyer, provide a reward to the premium buyer; and
in response to the sale to the second subsequent buyer, provide a reward to the second premium buyer.

8. The computer server of claim 1, wherein the subsequent buyer is a regular buyer and further configured to:
sell the copy of the digital work to the regular buyer at the regular price; and
sell, over a fourth network connection to a second subsequent buyer, a copy of the digital work to the second subsequent buyer; and
in response to the sale to the second subsequent buyer, provide a reward to the premium buyer but not the regular buyer.

9. The computer server of claim 1, further configured to:
sell additional copies of the digital work at the premium price only until a maximum quantity of sales at the premium price is attained.

10. The computer server of claim 1, further configured to:
determine if the premium buyer has previously purchased a copy of the digital work at the premium price; and
sell the copy of the digital work to the premium buyer at the premium price only if the premium buyer has not previously purchased a copy at the premium price.

11. A computer program product for promotion of digital works, the computer program product embodied on a non-transitory computer-readable medium, the computer program product comprising:
computer code for receiving a digital work from a publisher over a first network connection;
computer code for selling, over a second network connection to a premium buyer, a copy of the digital work to the premium buyer at the premium price;
computer code for selling, over a third network connection to a subsequent buyer, at a copy of the digital work to the subsequent buyer at the premium price or at a regular price; and
computer code for, in response to the sale to the subsequent buyer, providing a reward to the premium buyer.

12. The computer program product of claim 11, wherein the first network connection, the second network connection, and the third network connection comprise Internet connections.

13. The computer program product of claim 11, wherein the digital work comprises at least one of an audio track, a video, or a book.

14. The computer program product of claim 11, wherein the reward comprises a portion of revenue from the sale to the subsequent buyer.

15. The computer program product of claim 11, wherein the reward comprises redeemable credit.

16. The computer program product of claim 11, further comprising:
computer code for, in response to the sale of the digital work to the premium buyer, providing a portion of revenue from the sale to the publisher; and
computer code for, in response to the sale of the digital work to the subsequent buyer, providing a portion of revenue from the sale to the publisher.

17. The computer program product of claim 11, wherein the subsequent buyer is a second premium buyer and further comprising:
computer code for selling the copy of the digital work to the second premium buyer at the premium price; and
computer code for selling, over a fourth network connection to a second subsequent buyer, a copy of the digital work to the second subsequent buyer;
computer code for, in response to the sale to the second subsequent buyer, providing a reward to the premium buyer; and
computer code for, in response to the sale to the second subsequent buyer, providing a reward to the second premium buyer.

18. The computer program product of claim 11, wherein the subsequent buyer is a regular buyer and further comprising:
computer code for selling the copy of the digital work to the regular buyer at the regular price; and
computer code for selling, over a fourth network connection to a second subsequent buyer, a copy of the digital work to the second subsequent buyer; and
computer code for, in response to the sale to the second subsequent buyer, providing a reward to the premium buyer but not the regular buyer.

19. The computer program product of claim 11, further comprising:
computer code for selling additional copies of the digital work at the premium price only until a maximum quantity of sales at the premium price is attained.

20. The computer program product of claim 11, further comprising:
computer code for determining if the premium buyer has previously purchased a copy of the digital work at the premium price; and
computer code for selling the copy of the digital work to the premium buyer at the premium price only if the premium buyer has not previously purchased a copy at the premium price.
